(19) United States
(12) Patent Application Publication
(10) Pub. No.: US 2026/0368499 A1
(43) Pub. Date: Nov. 19, 2026

(54) STORAGE MEDIUM, INFORMATION PROCESSING APPARATUS FOR DISPLAYING AN OBJECT FOR REGISTERING AN IMAGE FOR A STICKER, AND METHOD FOR CONTROLLING INFORMATION PROCESSING APPARATUS

(71) Applicant: CANON KABUSHIKI KAISHA, Tokyo (JP)

(72) Inventor: JUNJI KAWATA, Tokyo (JP)

(21) Appl. No.: 19/659,558

(22) Filed: Apr. 27, 2026

(30) Foreign Application Priority Data
May 13, 2025 (JP) 2025-080631

(51) Int. Cl. G06N 3/0475

(52) U.S. Cl. CPC G06N 3/0475

(57) ABSTRACT

The present disclosure enables an image generated by a generative artificial intelligence (AI) to be easily registered as a sticker usable in a chat application. A method for controlling an information processing apparatus includes receiving information from a user, inputting the received information to an image generative AI, receiving a sound, adding sound data representing the received sound to an image generated by the image generative AI based on the received information, and displaying, on display, an object for registering the image with the sound data added thereto as a sticker usable in a chat application.

### BACKGROUND

### Field of the Technology

The present disclosure relates to a storage medium, an information processing apparatus, and a method for controlling an information processing apparatus.

### Description of the Related Art

Artificial Intelligence Generated Content (AIGC) (generative AI) systems are known to generate an image using a keyword input by a user. For example, a prompt constituted by a character string of a natural language is input to an AIGC system as the keyword (refer to US2023/0267652A1). The AIGC system generates an image containing an object corresponding to the prompt input by the user. Due to that, just inputting the prompt to the AIGC system allows the user to acquire the image containing the object corresponding to this prompt, such as a human or a vehicle.

Further, Japanese Patent Application No. 2024-007900 describes that a sketch is input to a generative AI and an image based on the sketch is generated thereby.

However, conventionally, a sticker with a sound added thereto in a chat application has been unable to be generated using generative AI.

### SUMMARY

According to an aspect of the present disclosure, a non-transitory computer-readable storage medium stores a computer program, and the computer program causes a computer of an information processing apparatus to perform receiving information from a user as first receiving, inputting the information received in the first receiving to an image generative artificial intelligence (AI), receiving a sound as second receiving, adding sound data representing the sound received in the second receiving to an image generated by the image generative AI based on the information input in the inputting, and displaying an object for registering the image with the sound data added thereto in the adding as a sticker of a chat application provided to the information processing apparatus on a display unit.

Features of the present disclosure will become apparent from the following description of embodiments with reference to the attached drawings. The following description of embodiments is described by way of example.

### BRIEF DESCRIPTION OF THE DRAWINGS

FIG. 1 illustrates the configuration of a system according to an embodiment of the present disclosure.

FIG. 2 is a block diagram illustrating the hardware configuration of a mobile terminal according to the present embodiment.

FIG. 3 is a block diagram illustrating the software configuration of the mobile terminal according to the present embodiment.

FIG. 4 is a block diagram illustrating the hardware configuration of a chat server according to the present embodiment.

FIG. 5 illustrates a user interface of the mobile terminal according to the present embodiment.

FIG. 6 illustrates a user interface of the mobile terminal according to the present embodiment.

FIG. 7 illustrates a user interface of the mobile terminal according to the present embodiment.

FIG. 8 illustrates a user interface of the mobile terminal according to the present embodiment.

FIG. 9 illustrates a user interface of the mobile terminal according to the present embodiment.

FIG. 10 illustrates a user interface of the mobile terminal according to the present embodiment.

FIG. 11 illustrates a user interface of the mobile terminal according to the present embodiment.

FIG. 12 illustrates a user interface of the mobile terminal according to the present embodiment.

FIG. 13 illustrates a user interface of the mobile terminal according to the present embodiment.

FIG. 14 illustrates a user interface of the mobile terminal according to the present embodiment.

FIG. 15 is a flowchart illustrating processing on the mobile terminal according to the present embodiment.

FIG. 16 is a flowchart illustrating processing on the mobile terminal according to the present embodiment.

FIG. 17 illustrates a user interface of the mobile terminal according to the present embodiment.

FIG. 18 illustrates a user interface of the mobile terminal according to the present embodiment.

FIG. 19 illustrates a user interface of the mobile terminal according to the present embodiment.

FIG. 20 illustrates a user interface of the mobile terminal according to the present embodiment.

FIG. 21 illustrates a user interface of the mobile terminal according to the present embodiment.

FIG. 22 illustrates a user interface of the mobile terminal according to the present embodiment.

FIG. 23 illustrates a user interface of the mobile terminal according to the present embodiment.

### DESCRIPTION OF THE EMBODIMENTS

In the following description, embodiments of the present technique will be described in detail with reference to the attached drawings. However, the embodiments that will be described below do not limit the present technique defined according to the claims, and not all combinations of features that will be described in the present embodiments are necessarily essential to a solution of the present technique.

### Embodiment

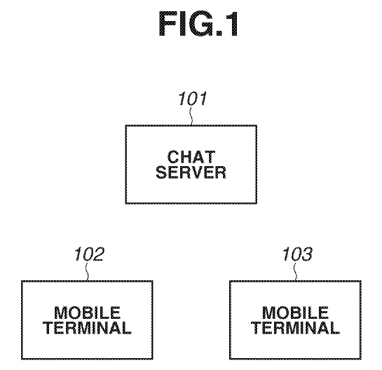

FIG. 1 illustrates an example of a system configuration according to the present embodiment.

The present system configuration includes a chat server 101, a mobile terminal 102, and a mobile terminal 103.

The mobile terminal 102 communicates with the chat server 101 via a base station wirelessly.

Further, the mobile terminal 103 also communicates with the chat server 101 via a base station wirelessly.

A user of the mobile terminal 102 operates the mobile terminal 102, by which the mobile terminal 102 posts a message and a sticker to the chat server 101. A user of the mobile terminal 103 operates the mobile terminal 103, by which the mobile terminal 103 can receive and display the message and the sticker posted to the chat server 101.

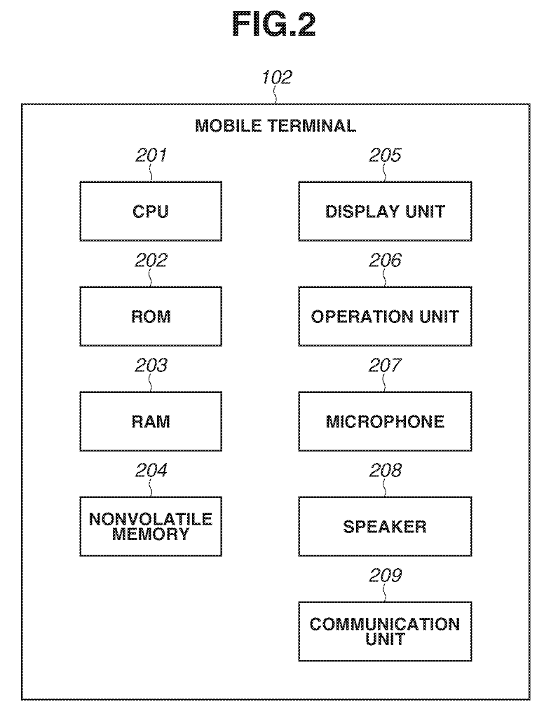

FIG. 2 illustrates the hardware configuration of the mobile terminal 102, which is an example of an information processing apparatus. The mobile terminal 103 has a hardware configuration similar to the mobile terminal 102.

The mobile terminal 102 includes a central processing unit (CPU) 201, a read only memory (ROM) 202, a random access memory (RAM) 203, a nonvolatile memory 204, a display unit 205, an operation unit 206, a microphone 207, a speaker 208, and a communication unit 209.

CPU is an abbreviation for Central Processing Unit. ROM is an abbreviation for Read Only Memory. RAM is an abbreviation for Random Access Memory.

The CPU 201 comprehensively controls the mobile terminal 102. The CPU 201 may perform processing in cooperation with a GPU. GPU is an abbreviation for Graphics Processing Unit.

The ROM 202 stores various kinds of programs read out by the CPU 201.

The RAM 203 functions as a work memory of the CPU 201.

The nonvolatile memory 204 is a memory capable of retaining data even when the mobile terminal 102 is powered off.

The display unit 205 displays various kinds of information, such as a screen, a message, and a sticker. The CPU 201 controls the display on the display unit 205.

The operation unit 206 is a touch panel configured integrally with the display unit 205. The operation unit 206 receives various kinds of operations from the user. Further, the operation unit 206 may include a hardware key, such as a home key for turning on and off the light of the screen and a power key for powering on and off the mobile terminal 102.

The microphone 207 receives sound information such as the user's voice and a surrounding ambient sound.

The speaker 208 outputs a sound.

The communication unit 209 carries out wireless communication, such as Wi-Fi.

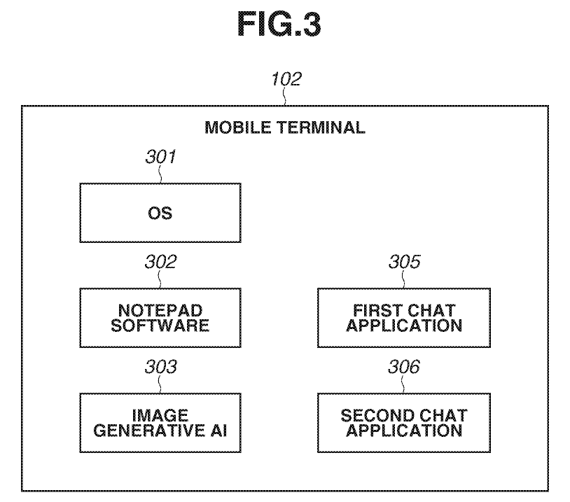

FIG. 3 illustrates the software configuration of the mobile terminal 102. These software applications are stored in the nonvolatile memory 204, and are read out into the RAM 203 and executed by the CPU 201. An operating system (OS) 301 may be stored in the ROM 202. The mobile terminal 103 has a software configuration similar to the mobile terminal 102.

The mobile terminal 102 includes the OS 301, notepad software 302, image generative artificial intelligence (AI) 303, a first chat application 305, and a second chat application 306. OS is an abbreviation for Operating System, and AI is an abbreviation for Artificial Intelligence.

The OS 301 is basic software for using an application and the like. The OS 301 manages and controls various components and programs working in the mobile terminal 102.

The notepad software 302 is software used for the user to keep a note using a text and/or graphics. This notepad software 302 is software bundled in the OS 301, and is software pre-installed when the mobile terminal 102 is purchased.

The image generative AI 303 is AI that generates an image based on input text information and a learning model. Further, the image generative AI 303 can also generate an image based on input graphics information and a learning model.

The first chat application 305 and the second chat application 306 are application software used for the user to post a message and a sticker.

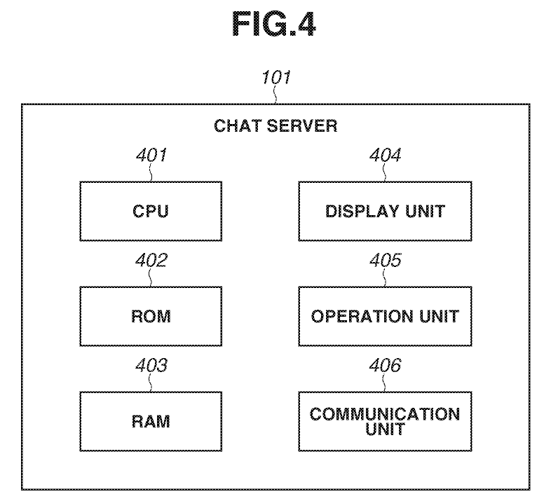

FIG. 4 is a block diagram illustrating the hardware configuration of the chat server 101.

The chat server 101 includes a CPU 401, a ROM 402, a RAM 403, a display unit 404, an operation unit 405, and a communication unit 406.

The CPU 401 comprehensively controls the chat server 101. The CPU 401 may perform processing in cooperation with a GPU. GPU is an abbreviation for Graphics Processing Unit.

The ROM 402 stores various kinds of programs read out by the CPU 401.

The RAM 403 functions as a work memory of the CPU 401.

The display unit 404 displays a screen.

The operation unit 405 is a keyboard and/or a mouse. The operation unit 405 receives various kinds of operations from the user.

The communication unit 406 carries out wired communication using a local area network (LAN) cable or wireless communication such as Wi-Fi.

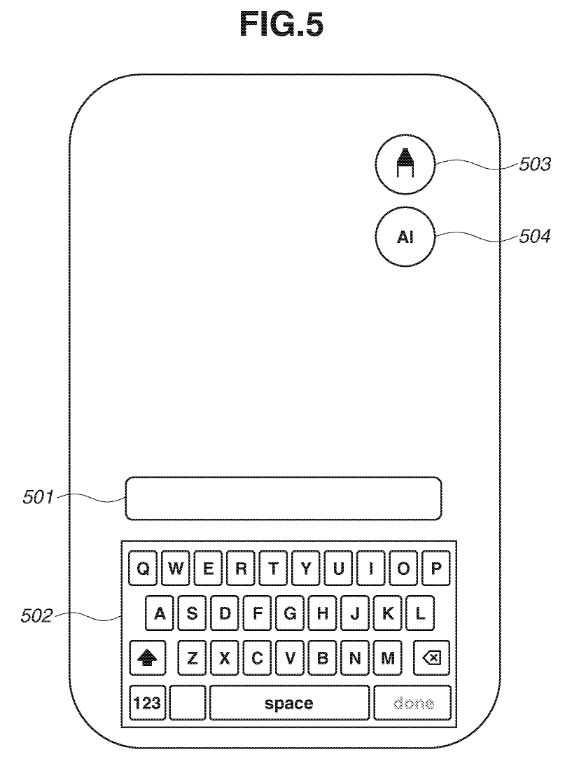

FIGS. 5-11 illustrate the display unit 205 of the mobile terminal 102.

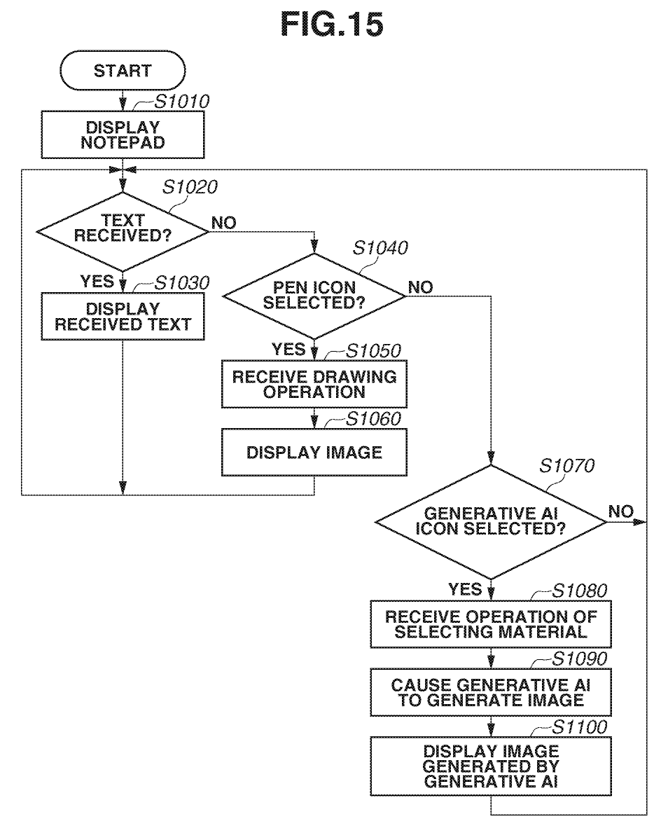

FIG. 15 is a flowchart illustrating processing according to the present embodiment. The CPU 201 reads out the program stored in the ROM 202 into the RAM 203 and executes the read program, by which the processing illustrated in the flowchart of FIG. 15 is realized.

In step S1010, the CPU 201 causes a screen of the notepad illustrated in FIG. 5 to be displayed on the display unit 205 by executing the notepad software 302. The screen of the notepad includes a text input field 501, a keyboard 502, a pen icon 503, and a generative AI icon 504. These objects are operated by the user via the touch panel of the operation unit 206.

In step S1020, the CPU 201 determines whether a text is received via the operation unit 206. If the CPU 201 determines that a text is received (YES in step S1020), the processing proceeds to step S1030. If the CPU 201 determines that no text is received (NO in step S1020), the processing proceeds to step S1040.

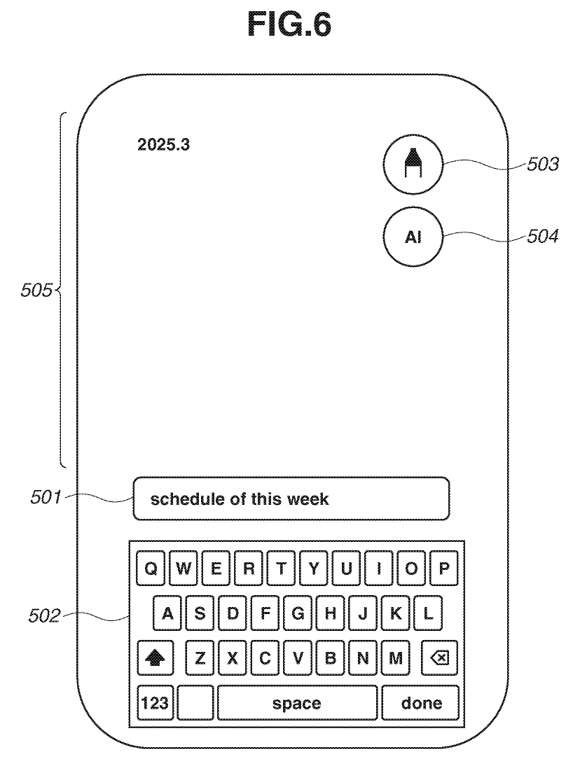

In step S1030, the CPU 201 causes the character string input using the keyboard 502 to be displayed in the text input field 501 as illustrated in FIG. 6. When a done key of the keyboard 502 is pressed with the character string input in the text input field 501, the character string input in the text input field 501 is displayed in a display region 505. After the CPU 201 performs the process of step S1030, the processing proceeds to step S1020.

In step S1040, the CPU 201 determines whether the pen icon 503 is selected.

If the CPU 201 determines that the pen icon 503 is selected (YES in step S1040), the processing proceeds to step S1050. If the CPU 201 determines that the pen icon 503 is not selected (NO in step S1040), the processing proceeds to step S1070.

In step S1050, the CPU 201 receives a drawing operation from the user.

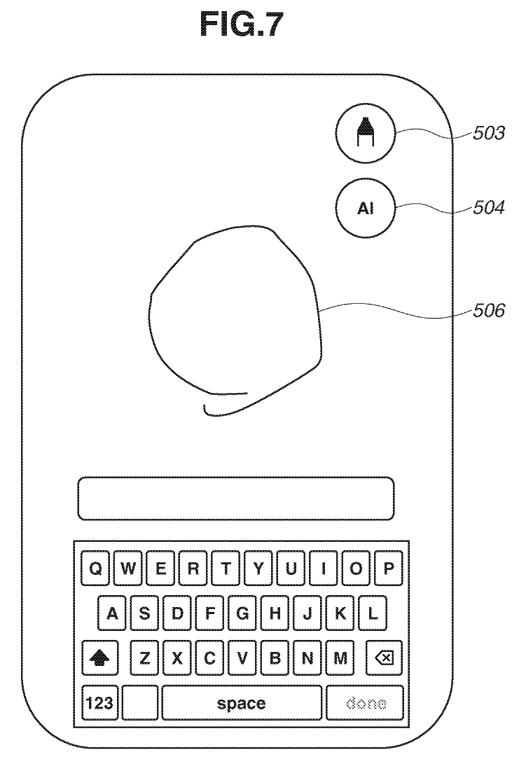

In step S1060, the CPU 201 causes a handwritten sketch image drawn with the drawing operation received in step S1050 to be displayed in the display region 505. FIG. 7 illustrates a screen on which a circle is drawn with the drawing operation in step S1050 and this circle is displayed in step S1060. After the CPU 201 performs the process of step S1060, the processing proceeds to step S1020.

In step S1070, the CPU 201 determines whether the generative AI icon 504 is selected. If the CPU 201 determines that the generative AI icon 504 is selected (YES in step S1070), the processing proceeds to step S1080. If the CPU 201 determines that the generative AI icon 504 is not selected (NO in step S1070), the processing proceeds to step S1020.

In step S1080, the CPU 201 receives an operation of selecting a material for causing the image generative AI 303 to generate an image. The material may be either a drawn image or a text input to the text input field 501 using the keyboard 502. Alternatively, the material may be a drawn handwritten text. The present example will be described assuming that the circle illustrated in FIG. 7 is selected as the material.

In step S1090, the CPU 201 causes the image generative AI 303 to generate an image.

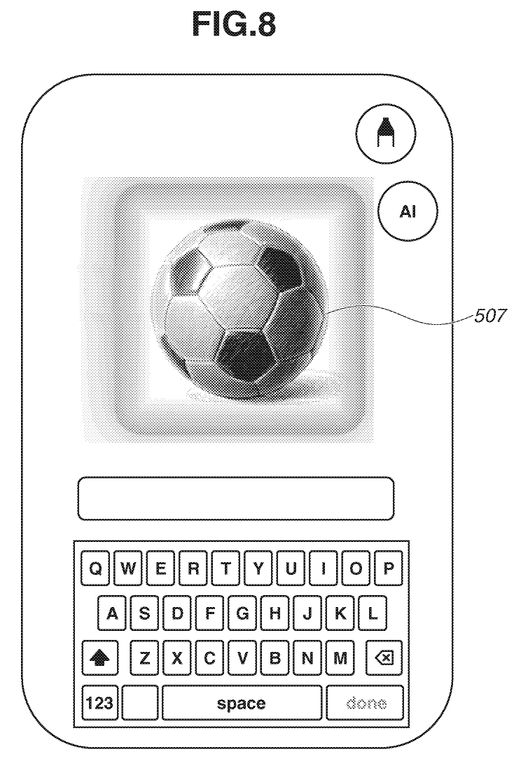

In step S1100, the CPU 201 causes the image generated by the image generative AI 303 to be displayed on the display unit 205. A soccer ball image 507 illustrated in FIG. 8 is an example of the image generated by the image generative AI 303 using the circle as the material.

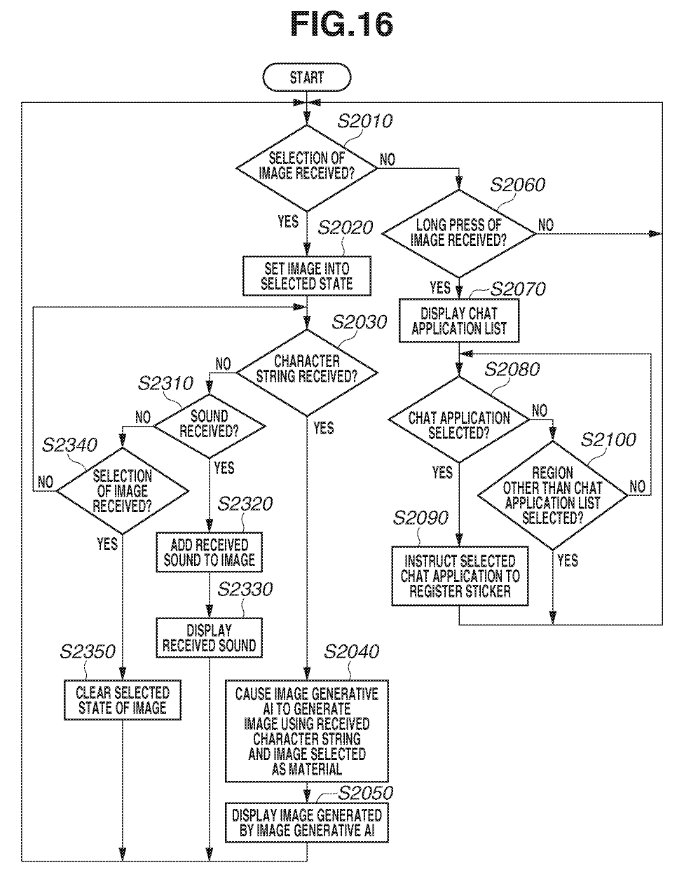

FIG. 16 is a flowchart illustrating processing according to the present embodiment. The CPU 201 reads out the program stored in the ROM 202 into the RAM 203 and executes the read program, by which the processing illustrated in the flowchart of FIG. 16 is realized.

In step S2010, the CPU 201 determines whether selection of the image 507 generated by the image generative AI 303 is received. If the CPU 201 determines that selection of the image is received (YES in step S2010), the processing proceeds to step S2020. If the CPU 201 determines that no selection of the image is received (NO in step S2010), the processing proceeds to step S2060.

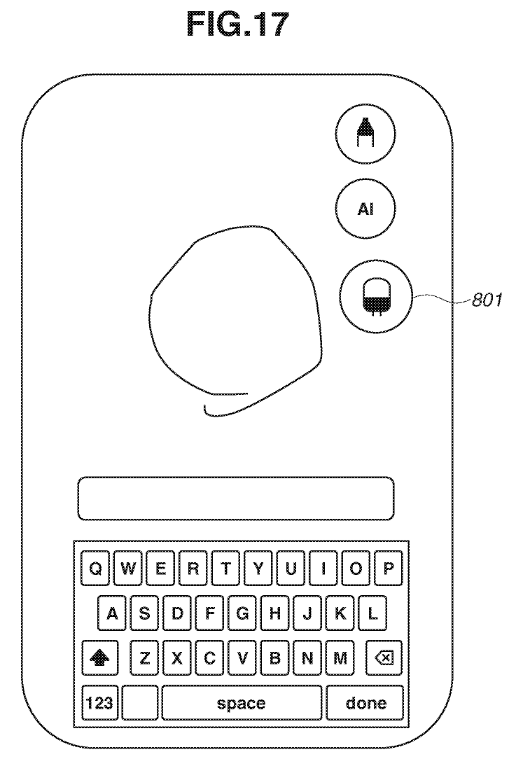

In step S2020, the CPU 201 sets the image into a selected state. When the image is set in the selected state, the CPU 201 causes a screen illustrated in FIG. 17 to be displayed on the display unit 205. A sound icon 801 illustrated in FIG. 17 is an icon displayed when the image is set in the selected state. A microphone image is drawn in the sound icon 801.

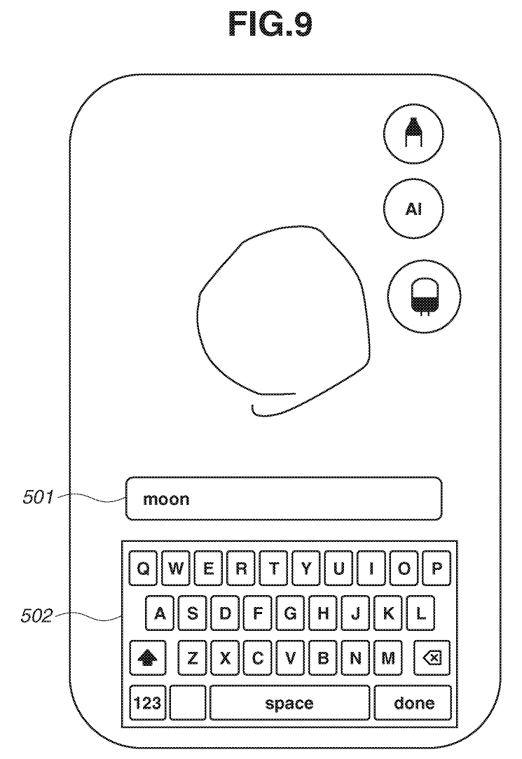

In step S2030, the CPU 201 determines whether a character string is received. If the CPU 201 determines that a character string is received (YES in step S2030), the processing proceeds to step S2040. FIG. 9 illustrates an example when a character string is received. If the CPU 201 determines that no character string is received (NO in step S2030), the processing proceeds to step S2310.

In step S2040, the CPU 201 causes the image generative AI 303 to generate an image using the received character string and the image selected as the material.

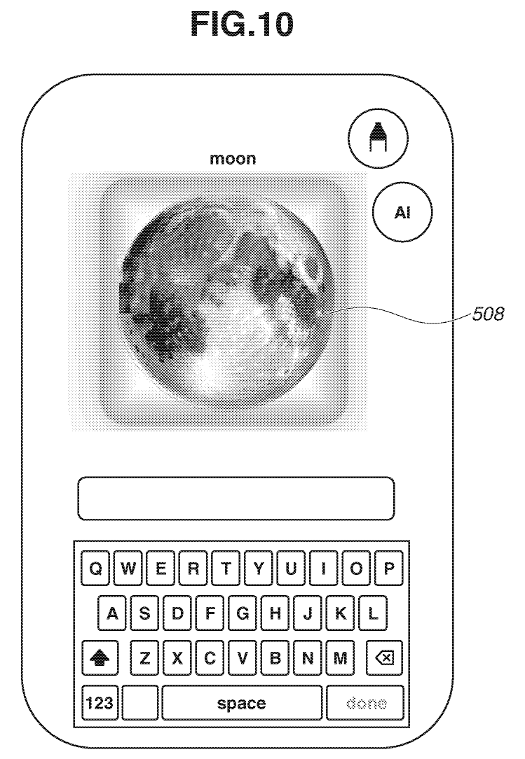

In step S2050, the CPU 201 causes the image generated by the image generative AI 303 to be displayed on the display unit 205. FIG. 10 illustrates an example of the image generated in step S2050. This is an example when the image is generated by the image generative AI 303 based on the character string "moon" and the circle selected as the material and the generated image is displayed. After that, the processing proceeds to step S2010.

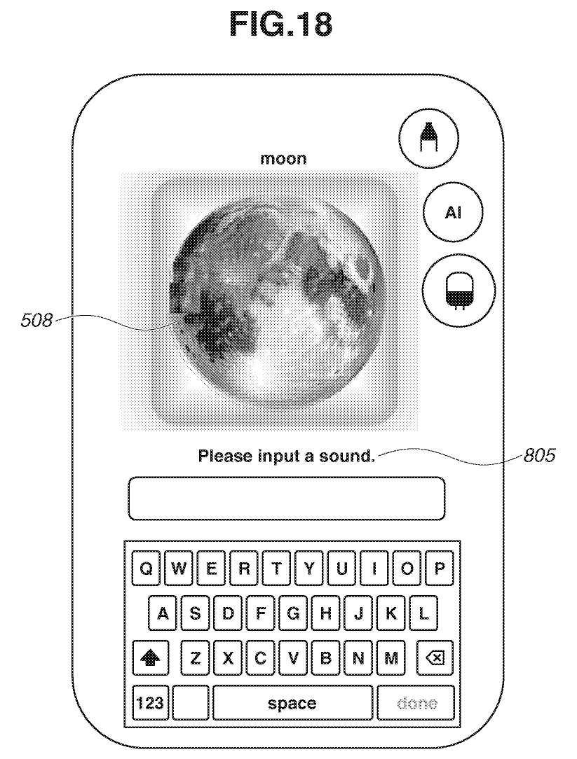

If the processing proceeds from step S2030 to step S2310, the CPU 201 determines whether the sound icon 801 is selected and a sound is input via the microphone 207 with the sound icon 801 selected. For example, when the sound icon 801 is selected with the image illustrated in FIG. 10 displayed, the CPU 201 causes a screen illustrated in FIG. 18 to be displayed on the display unit 205. A message 805 reading "please input a sound" is displayed on the screen illustrated in FIG. 18. If the CPU 201 determines that a sound is input (YES in step S2310), the processing proceeds to step S2320. If the CPU 201 determines that no sound is input (NO in step S2310), the processing proceeds to step S2340.

In step S2320, the CPU 201 generates sound data representing the received sound and adds the generated sound data to the image set in the selected state in step S2020. For example, the CPU 201 converts the generated sound data into a file such as MPEG Audio Layer III (MP3), and stores it into the nonvolatile memory 204 in association with the image set in the selected state in step S2020.

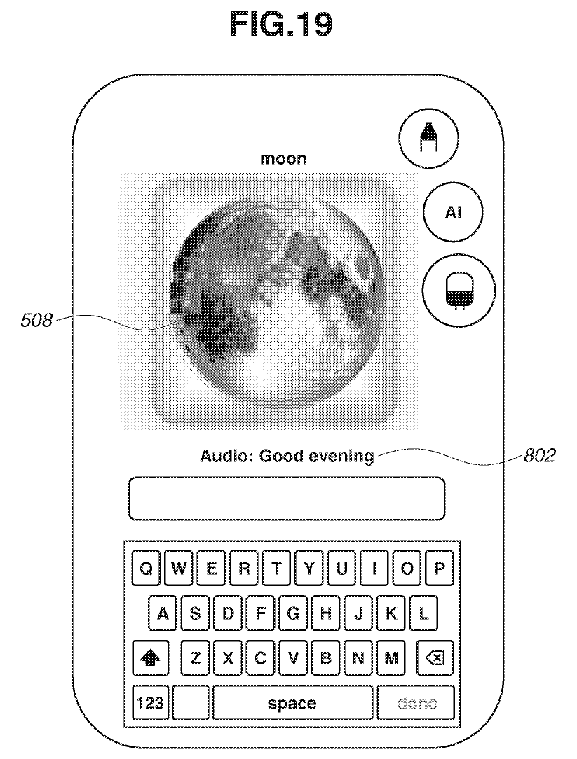

In step S2330, the CPU 201 generates a character string forming a text based on the generated sound data and causes the generated character string to be displayed on the display unit 205. After that, the processing proceeds to step S2010. For example, a known method described in Japanese Patent Laid-Open No. 2019-138988 can be used as a method for converting the sound into the character string. FIG. 19 illustrates an example when the converted character string is displayed in a region 802. In a case where there is no character available for the conversion into the character string, such a case can be handled just by displaying a message indicating the lack of a character string into which the sound can be converted.

If the processing proceeds from step S2310 to step S2340, the CPU 201 determines whether selection of the image in the selected state is received. If the CPU 201 determines that selection of the image in the selected state is received (YES in step S2340), in step S2350, the CPU 201 clears the selected state of the image. Then, the processing proceeds to step S2010. On the other hand, if the CPU 201 determines that no selection of the image in the selected state is received (NO in step S2340), the processing proceeds to step S2030.

If the processing proceeds from step S2010 to step S2060, in step S2060, the CPU 201 determines whether a long press of the image is received (whether the image is touched for a predetermined time). If the CPU 201 determines that no long press of the image is received (NO in step S2060), the processing in step S2010 is repeated. If the CPU 201 determines that a long press of the image is received (YES in step S2060), the processing proceeds to step S2070.

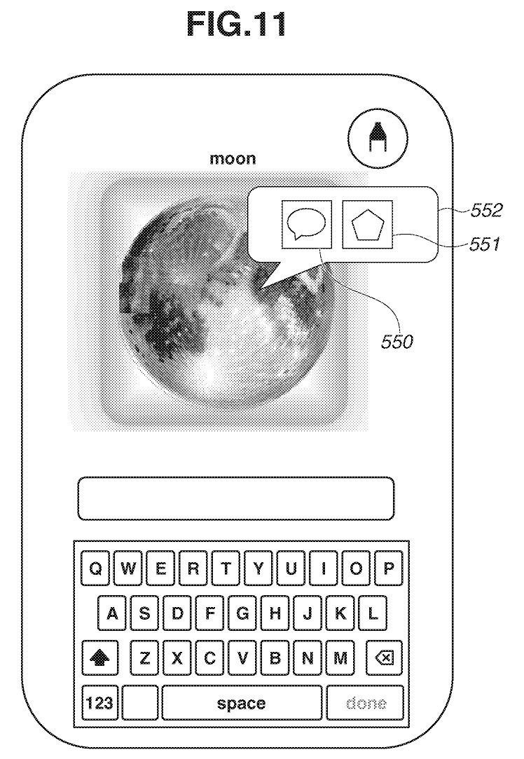

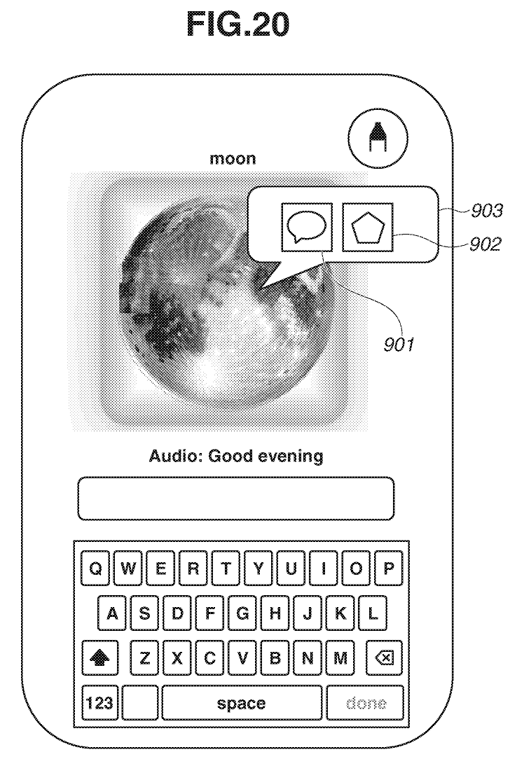

In step S2070, the CPU 201 causes a chat application list 552 to be displayed on the display unit 205. Information about each chat application contained in the chat application list 552 is stored into the nonvolatile memory 204 as application information when each chat application is installed into the mobile terminal 102. For example, an icon of each chat application displayed in the chat application list 552 is stored into the nonvolatile memory 204. The CPU 201 refers to this information in the nonvolatile memory 204, and causes the chat application list 552 including the icon corresponding to each chat application to be displayed on the display unit 205. FIG. 11 illustrates an example when the chat application list 552 is displayed to register an image not accompanied by data representing a sound. The chat application list 552 illustrated in FIG. 11 includes an icon 550 of the first chat application 305 and an icon 551 of the second chat application 306. The present embodiment has been described citing the example of displaying two icons, but may be configured in such a manner that as many icons as installed chat applications are displayed in a case where three or more chat applications are installed in the mobile terminal 102. When the user registers an image accompanied by data representing a sound, a screen illustrated in FIG. 20 is displayed instead of the screen illustrated in FIG. 11. FIG. 20 illustrates an example when a chat application list 903 is displayed to register an image accompanied by data representing a sound. The chat application list 903 illustrated in FIG. 20 includes an icon 901 of the first chat application 305 and an icon 902 of the second chat application 306.

In step S2080, the CPU 201 determines whether any chat application is selected via the icon from the chat application list. If the CPU 201 determines that some chat application is selected (YES in step S2080), the processing proceeds to step S2090. If the CPU 201 determines that no chat application is selected (NO in step S2080), the processing proceeds to step S2100.

In step S2090, the CPU 201 instructs the chat application selected via the icon to register the image generated by the image generative AI 303. If the first chat application 305 is selected via the icon 550 of the first chat application 305, the CPU 201 instructs the first chat application 305 to register the image generated by the image generative AI 303 as a sticker. On the other hand, if the second chat application 306 is selected via the icon 551 of the second chat application 306, the CPU 201 instructs the second chat application 306 to register the image generated by the image generative AI 303 as a sticker. In each case, when registering an image accompanied by sound data representing a sound, the CPU 201 instructs the chat application to register the image generated by the image generative AI 303 and the sound data added to this image as a sticker. After that, the processing proceeds to step S2010.

In step S2100, the CPU 201 determines whether a region other than the chat application list 552 is selected. If the CPU 201 determines that a region other than the chat application list 552 is selected (YES in step S2100), the processing proceeds to step S2010. On the other hand, if the CPU 201 determines that a region other than the chat application list 552 is not selected (NO in step S2100), the processing proceeds to step S2080.

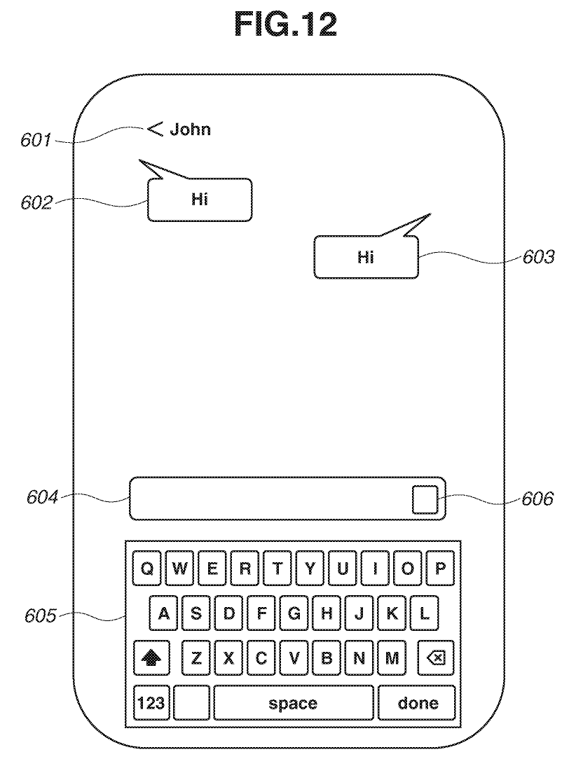

FIGS. 12-14 and 21-23 illustrate the display unit 205 of the mobile terminal 102. These drawings illustrate chat screens displayed by executing the first chat application 305.

A recipient user 601, a comment 602 received from the recipient user 601, and a comment 603 from a sender user are displayed on the chat screen.

Further, a character string input field 604, a keyboard 605, and a sticker calling button 606 are displayed on the chat screen.

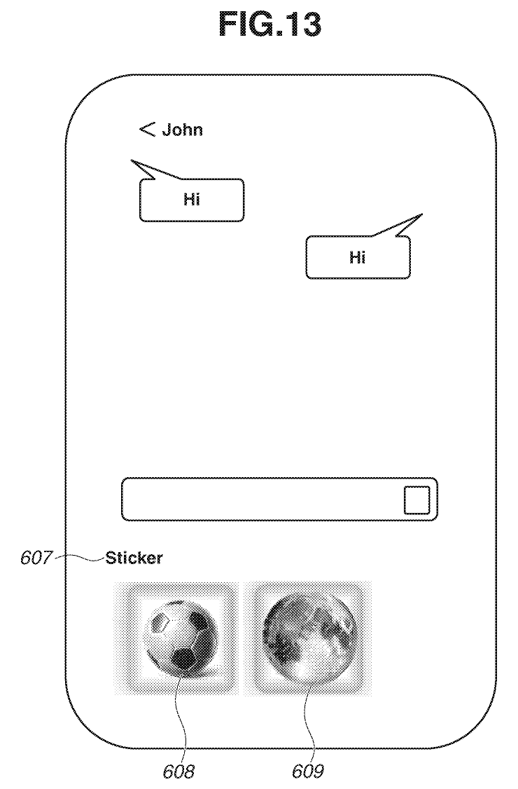

When the sticker calling button 606 is selected, the screen illustrated in FIG. 13 is displayed. A sticker 609 registered with the first chat application 305 is registered on the screen illustrated in FIG. 13. This example is an example when a sticker without sound data added thereto is registered.

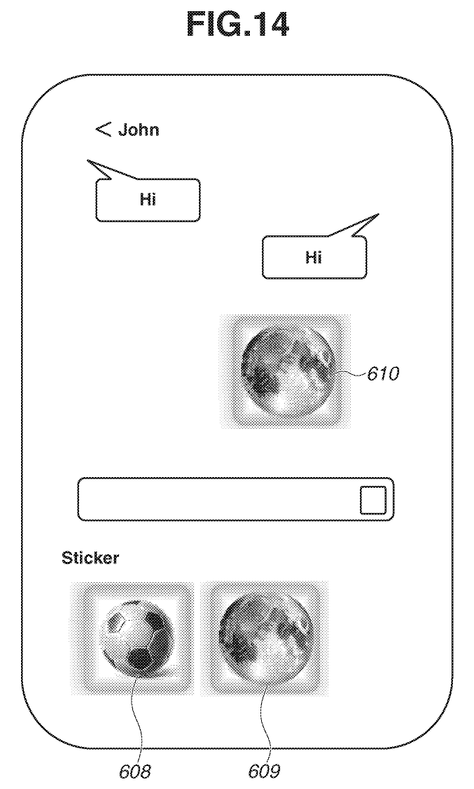

When the sticker 609 is selected in this state, the CPU 201 posts the sticker 609 to the chat server 101 as illustrated in FIG. 14.

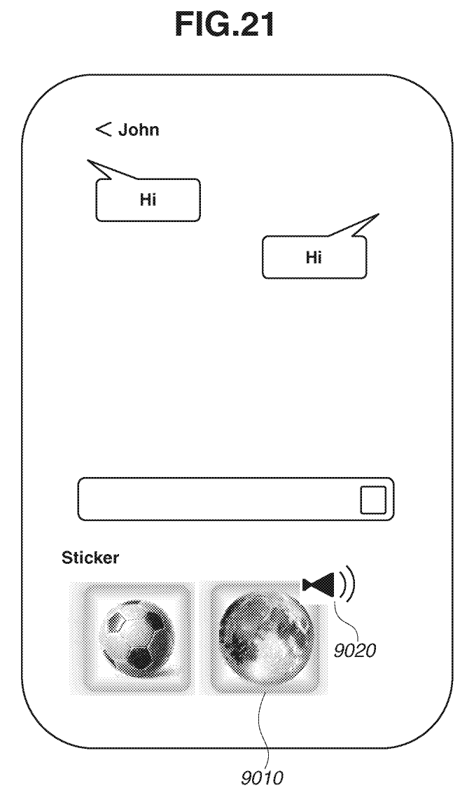

On the other hand, when a sticker 9010 with sound data added thereto is registered, the screen illustrated in FIG. 21 is displayed instead of the screen illustrated in FIG. 13. A sound icon 9020 indicates that sound data representing a sound is added to the sticker 9010.

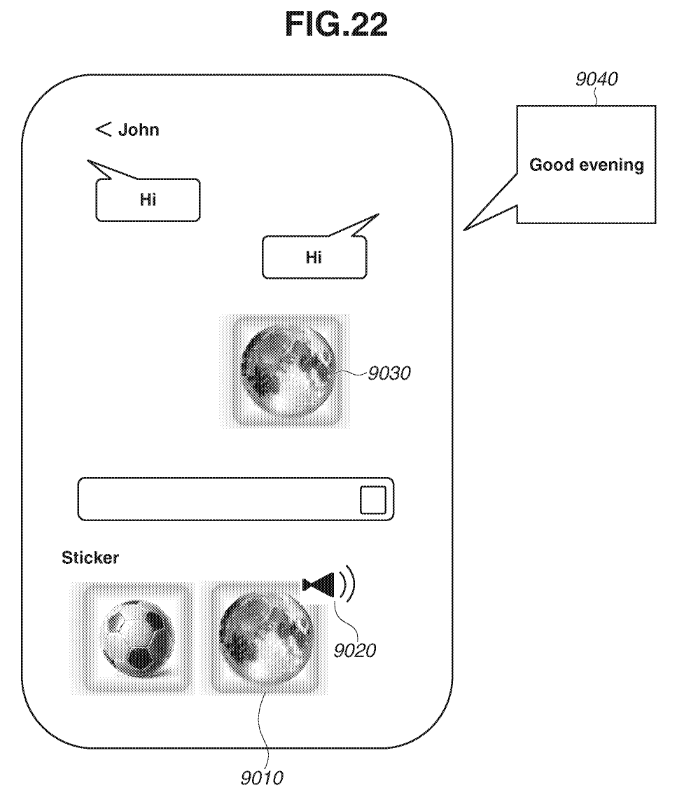

When the sticker 9010 with the sound data added thereto is selected in this state, the CPU 201 posts a sticker 9030 to the chat server 101 as illustrated in FIG. 22. At this time, the CPU 201 plays back the sound data associated with this sticker 9030 via the speaker 208. In the present example, sound data "Good evening" is associated with the sticker 9030, and therefore the CPU 201 causes the speaker 208 to output a sound 9040 "Good evening". This allows the user of the mobile terminal 102 to easily confirm the sound sent by posting the sticker 9030. The CPU 201 may cause the sound data added to the sound-attached sticker 9010 to be output via the speaker 208 without posting the sticker 9010 according to selection of the sound icon 9020 before posting the sticker 9010.

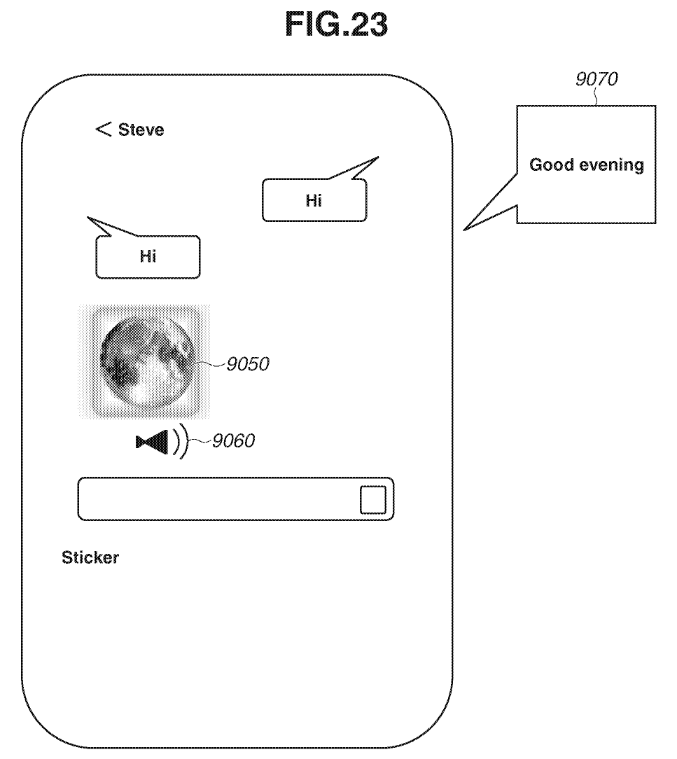

FIG. 23 illustrates a screen of the mobile terminal 103, which is the side that receives and displays the posted sticker 9030. A sticker 9050 is the same as the sticker 9030 illustrated in FIG. 22. A sound icon 9060 indicates that the sticker 9050 is a sticker with a sound added thereto. The CPU of the mobile terminal 103 causes a sound 9070 "Good evening" to be output via the speaker of the mobile terminal 103 when displaying the screen illustrated in FIG. 22.

In this manner, according to the present embodiment, an image generated by generative AI can be easily registered with a chat application.

### Other Embodiments

The above-described embodiment has been described citing the example in which the CPU 201 instructs the chat application selected via the icon to register the image generated by the image generative AI 303 in step S2090. Now, the data format of a registrable sticker or the data format of registrable sound data may be predetermined according to a chat application that is the registration destination. In light thereof, the CPU 201 may issue a registration instruction after changing the data format of the sticker and the data format of the sound data according to the selected chat application. The data format of a sticker and the data format of sound data registrable for each chat application are registered by the CPU 201 into the nonvolatile memory 204 as attribute information for each chat application when the chat application is downloaded to the mobile terminal 102. Then, according to selection of a chat application, the CPU 201 acquires information about the data format of a sticker and the data format of sound data registrable by this chat application from the nonvolatile memory 204. The CPU 201 identifies the data format of a sticker and the data format of sound data registrable by the selected chat application based on the acquired information. Now, the present example will be described assuming that a Portable Network Graphics (PNG) file and a bitmap (BMP) file are predetermined as the data format of a sticker registrable with the first chat application 305 and the data format of a sticker registrable with the second chat application 306, respectively. PNG is an abbreviation for Portable Network Graphics. Further, the present example will be described assuming that a RIFF wave audio format (WAV) file and an MP3 file are predetermined as the data format of sound data registrable with the first chat application 305 and the data format of sound data registrable with the second chat application 306, respectively. WAV is an abbreviation for RIFF wave audio format. Then, for example, when the first chat application 305 is selected via the icon 550 of the first chat application 305, the CPU 201 converts the image generated by the image generative AI 303 into a PNG file. Further, the CPU 201 converts the sound data added to the image into a WAV file. Then, the CPU 201 instructs the first chat application 305 to register the converted image and the converted sound data as a sticker. On the other hand, when the second chat application 306 is selected via the icon 551 of the second chat application 306, the CPU 201 converts the image generated by the image generative AI 303 into a BMP file. Further, the CPU 201 converts the sound data added to the image into an MP3 file. Then, the CPU 201 instructs the second chat application 306 to register the converted image and the converted sound data as a sticker. In a case where the file format of the original sound data and the file format of sound data registrable with the selected chat application are the same, such a case can be handled just by refraining from converting it. This allows the image generated by the image generative AI 303 and the sound data added to this image to be registered while being converted according to the data format of the chat application that is the registration destination.

Further, the CPU 201 may issue a registration instruction after changing the size of the image according to the selected chat application. The height and width sizes of a sticker registrable for each chat application are registered by the CPU 201 into the nonvolatile memory 204 as attribute information of each chat application when this chat application is downloaded to the mobile terminal 102. Then, according to selection of a chat application, the CPU 201 acquires information about the height and width sizes of a sticker registrable by this chat application from the nonvolatile memory 204. The CPU 201 identifies the height and width sizes of a sticker registrable by the selected chat application based on the acquired information. The height and width sizes of a registrable sticker may be predetermined according to the chat application that is the registration destination. The present example will be described assuming that 240 pixels high × 240 pixels wide and 360 pixels high × 360 pixels wide are predetermined as the sizes for the first chat application 305 and the sizes for the second chat application 306, respectively. Then, for example, when the first chat application 305 is selected via the icon 550 of the first chat application 305, the CPU 201 resizes the image generated by the image generative AI 303 to a first size (240 pixels high × 240 pixels wide). Then, the CPU 201 instructs the first chat application 305 to register the image in the changed size as a sticker. On the other hand, when the second chat application 306 is selected via the icon 551 of the second chat application 306, the CPU 201 resizes the image generated by the image generative AI 303 to a second size larger than the first size. In this case, the second size is 360 pixels high × 360 pixels wide. Then, the CPU 201 instructs the second chat application 306 to register the image in the changed size as a sticker. When the size of a sticker managed by the first chat application 305 is limited to the first size, and the size of a sticker managed by the second chat application 306 is limited to the second size, the CPU 201 can create a sticker according to each size to register it.

Further, the data size of a registrable image may be limited depending on an application that is the registration destination. In light thereof, the CPU 201 may issue a registration instruction after changing the data size of the image according to the selected chat application. The data size of a sticker registrable for each chat application is registered by the CPU 201 into the nonvolatile memory 204 as attribute information of each chat application when this chat application is downloaded to the mobile terminal 102. Then, according to selection of a chat application, the CPU 201 acquires information about the data size of a sticker registrable by this chat application from the nonvolatile memory 204. The CPU 201 identifies the data size of a sticker registrable by the selected chat application based on the acquired information. Now, the present example will be described assuming that the data size of a sticker is limited to 1 megabyte (MB) per sticker for the first chat application 305 and 2 MB per sticker for the second chat application 306. In this case, the CPU 201 may issue a registration instruction after confirming that the data size of the image that the selected chat application is instructed to register does not exceed the data size of an image registrable with the selected chat application. For example, when the first chat application 305 is selected via the icon 550 of the first chat application 305, the CPU 201 determines whether the data size of the image generated by the image generative AI 303 exceeds 1 MB. Then, if determining that this data size does not exceed 1 MB, the CPU 201 instructs the first chat application 305 to register this image as a sticker. On the other hand, if determining that this data size exceeds 1 MB, the CPU 201 notifies the display unit 205 of an error indicating that this data cannot be registered. On the other hand, when the second chat application 306 is selected via the icon 551 of the second chat application 306, the CPU 201 determines whether the data size of the image generated by the image generative AI 303 exceeds 2 MB. Then, if determining that this data size does not exceed 2 MB, the CPU 201 instructs the second chat application 306 to register this image as a sticker. On the other hand, if determining that this data size exceeds 2 MB, the CPU 201 notifies the display unit 205 of an error indicating that this data cannot be registered. In this manner, the CPU 201 can register the sticker with the chat application after confirming the upper limit value on the data size of a registrable sticker. Further, when the sticker cannot be registered, the user can be easily aware of it by viewing that.

Further, the data size of a registrable sound may be limited depending on an application that is the registration destination. In light thereof, the CPU 201 may issue a registration instruction after changing the data size of the sound according to the selected chat application. The data size of a sticker registrable for each chat application is registered by the CPU 201 into the nonvolatile memory 204 as attribute information of each chat application when this chat application is downloaded to the mobile terminal 102. Then, according to selection of a chat application, the CPU 201 acquires information about the data size of sound data of a sticker registrable by this chat application from the nonvolatile memory 204. The CPU 201 identifies the data size of sound data of a sticker registrable by the selected chat application based on the acquired information. Now, the present example will be described assuming that the data size of sound data is limited to 2 MB per sticker for the first chat application 305 and 4 MB per sticker for the second chat application 306. In this case, the CPU 201 may issue a registration instruction after confirming that the data size of the sound data of the image that the selected chat application is instructed to register does not exceed the data size of sound data registrable with the selected chat application. For example, when the first chat application 305 is selected via the icon 550 of the first chat application 305, the CPU 201 determines whether the data size of the sound data added to the image generated by the image generative AI 303 exceeds 2 MB. Then, if determining that this data size does not exceed 2 MB, the CPU 201 instructs the first chat application 305 to add this sound data to the sound data of the image to register it as a sticker. On the other hand, if determining that this data size exceeds 2 MB, the CPU 201 notifies the display unit 205 of an error indicating that the sound data cannot be registered. On the other hand, when the second chat application 306 is selected via the icon 551 of the second chat application 306, the CPU 201 determines whether the data size of the sound data added to the image generated by the image generative AI 303 exceeds 4 MB. Then, if determining that this data size does not exceed 4 MB, the CPU 201 instructs the second chat application 306 to register these image and sound data as a sticker. On the other hand, if determining that this data size exceeds 4 MB, the CPU 201 notifies the display unit 205 of an error indicating that the sound data cannot be registered. In this manner, the CPU 201 can register the sticker with the chat application after confirming the upper limit value on the data size of sound data of a registrable sticker. Further, when the sound data cannot be registered, the user can be easily aware of it by viewing that.

Further, the CPU 201 may be configured to determine whether the content of the image generated by the image generative AI 303 is a content registrable as a sticker when the chat application is selected. Then, if determining that the image generated by the image generative AI 303 is a content registrable as a sticker, the CPU 201 instructs the selected chat application to register this image as a sticker. On the other hand, if determining that the content of the image generated by the image generative AI 303 is a content non-registrable as a sticker, the CPU 201 causes an error indicating that this image cannot be registered to be displayed on the display unit 205. In this regard, the non-registrable content is, for example, a mostly light-colored image or a simple enumeration of numbers.

The above-described embodiments have been described citing the example in which the content of the image generated by the image generative AI 303, with sound data representing a sound being added thereto, is registered as the sticker. However, the present technique is not limited thereto, and may be configured in such a manner that the content of the image generated by the image generative AI 303, with motion added thereto, is registered as the sticker. In this case, a motion icon for adding motion to the image generated by the image generative AI 303 is displayed on the screen illustrated in FIG. 17. Then, when the motion icon is selected, the user inputs a character string indicating motion that he/she wants to add to the image generated by the image generative AI 303 to the text input field illustrated in FIG. 17. The input character string is fed to the image generative AI 303 as a prompt indicating the motion of the image. Upon receiving this prompt, the image generative AI 303 generates a moving image based on the fed image and returns it to the CPU 201. The CPU 201 registers the moving image with the chat application selected from the chat application list. The CPU 201 may further add sound data representing a sound input via the sound icon 801 to the moving image and register it with the chat application selected from the chat application list as a sticker. The animated sticker is displayed in the sticker list on the screen illustrated in FIG. 22, and the CPU 201 posts it to the chat server 101 as a moving sticker according to selection of it on the screen illustrated in FIG. 22.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-080631, filed May 13, 2025, which is hereby incorporated by reference herein in its entirety.

What is claimed is:

1. A non-transitory computer-readable storage medium for storing a computer program, the computer program, when executed by one or more processor of an information processing apparatus, causes the information processing apparatus to perform operations including:
receiving information from a user;
inputting the received information to an image generative artificial intelligence (AI);
receiving a sound;
adding sound data representing the received sound to an image generated by the image generative AI based on the received information; and
displaying, on display, an object for registering the image with the sound data added thereto as a sticker usable in a chat application.

2. The storage medium according to claim 1, wherein the object is displayed when the image displayed on the display is selected by the user.

3. The storage medium according to claim 1, wherein the object is displayed when the image displayed on the display is touched for a predetermined time.

4. The storage medium according to claim 1, wherein execution of the program further causes the information processing apparatus to display a plurality of icons of a plurality of chat applications on the display when the image displayed on the display is selected by the user, and issue an instruction to register the image as a sticker usable in a chat application corresponding to an icon selected by the user from the plurality of icons.

5. The storage medium according to claim 1, wherein the information processing apparatus includes notepad software, and
wherein the first receiving includes receiving the information with the notepad software.

6. The storage medium according to claim 5, wherein the information is a text.

7. The storage medium according to claim 5, wherein the information is handwritten characters.

8. The storage medium according to claim 5, wherein the information is a handwritten image.

9. The storage medium according to claim 1, wherein execution of the computer program further causes the information processing apparatus to receive a character string indicating motion as third receiving, and
wherein cause the image generative AI to add the sound data representing the received sound and the received motion indicated by the character string indicating the motion to the image generated by the image generative AI based on the input information.

10. A method for controlling an information processing apparatus, the method comprising:
receiving information from a user;
inputting the received information to an image generative AI;
receiving a sound;
adding sound data representing the received sound to an image generated by the image generative AI based on the received information; and
displaying, on display, an object for registering the image with the sound data added thereto as a sticker usable in a chat application.

11. An information processing apparatus comprising:
a first reception unit configured to receive information from a user;
an input unit configured to input the information received by the first reception unit to an image generative AI;
a second reception unit configured to receive a sound;
an addition unit configured to add sound data representing the sound received by the second reception unit to an image generated by the image generative AI based on the received information; and
a display control unit configured to display, on display, an object for registering the image with the sound data added thereto by the addition unit as a sticker usable in a chat application.
